(19) United States
(12) Patent Application Publication
(10) Pub. No.: US 2001/0048787 A1
(43) Pub. Date: Dec. 6, 2001

(54) Optical signal generator for high speed multi-fiber optical switching

(76) Inventor: Donald C. Conemac, Simi Valley, CA (US)

Correspondence Address: MYERS, DAWES & ANDRAS LLP, 19900 MacArthur Blvd., Suite 1150, Irvine, CA, 92612, US

(21) Appl. No.: 09/854,863

(22) Filed: May 14, 2001

Related U.S. Application Data
(60) Provisional application No. 60/204,236, filed on May 15, 2000.

(51) Int. Cl. G02B 6/28

(52) U.S. Cl. 385/24

(57) ABSTRACT

An optical signal generator suitable for high capacity multi-fiber optical data transmission or switching applications is disclosed. An optical signal generator, adapted for use in a fiber optic network, comprises a plurality of optical fibers respectively coupled to plural nodes of the fiber optic network. The optical signal generator includes an input optical channel providing a light beam and an acousto-optic modulator receiving the light beam and providing a plurality of separate output light beams. Each of the output light beams is independently optically coupled to a respective optical fiber. An acousto-optic modulator controller circuit is coupled to receive a data input and drives the acousto-optic modulator to independently modulate the plural output beams based on the input data.

### RELATED APPLICATION INFORMATION

The present application claims priority under 35 USC 119 (e) of provisional application serial No. 60/204,236 filed May 15, 2000 the disclosure of which is incorporated herein by reference.

### BACKGROUND OF THE INVENTION

1. Field of the Invention

The present invention relates to optical signal generators and optical switches and related methods. The present invention further relates to data networks and, in particular, to fiber optical data networks and methods of transmitting and receiving data along fiber optical data networks.

2. Background of the Prior Art and Related Information

Fiber optic data distribution networks are becoming increasingly important for the provision of high bandwidth data links to commercial and residential locations. Such systems employ optical fibers to transmit data in the form of modulated optical signals, which provides very high bandwidth data transmission and is the reason for the increasing importance of fiber optic networks. Since fiber optic data distribution networks are light based they must employ optical signal generators to convert user data in the form of electrical signals to modulated light which is coupled into the optical fiber. In particular, optical transmitters (or “transceivers” when combined with a receiver in one device) are employed throughout fiber optic distribution networks to couple electronic input data into the optical network. Fiber optic data distribution networks also employ switches at various locations throughout the network. For example, in the Internet, portions of which are fiber optic based, routers are employed to direct data packets to their destination. These switches are typically electrical, not optical, in nature. Such switches thus involve the use of optical receivers to convert the optical signals to electrical signals and optical signal generators to convert the signals back to modulated light. Therefore, optical signal generators are also a key component of routers and other switches employed in optical fiber networks.

At various nodes in an optical fiber data network it may be necessary to couple the node to multiple optical fibers. For example, in an all fiber network nodes close to the network backbone will typically couple to multiple fibers. Also, in combined wire and optical networks, such as the Internet, multiple fiber coupling may be employed at many locations. In such multiple fiber nodes the associated optical signal generators can become very complex and expensive, especially where high data rates are desired. More specifically, at multi-fiber nodes a separate optical transmitter is typically employed for each fiber. Each optical transmitter comprises a laser diode which is driven by the electrical input data signals to modulate the laser light to be transmitted down the particular fiber. As the number of fibers at the node is increased the need for multiple optical transmitters and associated control circuitry causes the implementation cost and complexity to rapidly increase. Also, the space requirements for such a multi-fiber multi-transmitter implementation can rapidly become a problem. This is particularly true since dense packing of the transmitters is not possible due to heat generation.

Accordingly, it will be appreciated that a need presently exists for an efficient and cost effective optical signal generator suitable for high capacity multi-fiber optical data transmission or switching applications. A need further exists for an improved fiber optic data network employing more efficient multi-fiber optical signal generation.

### SUMMARY OF THE INVENTION

The present invention provides an efficient and cost effective optical signal generator suitable for high capacity multi-fiber optical data transmission or switching applications. The present invention further provides an improved fiber optic data network employing more efficient multi-fiber optical signal generation.

In a first aspect, the present invention provides an optical signal generator suitable for high capacity multi-fiber optical data transmission or switching applications in a fiber optic network. The optical signal generator comprises a plurality of optical fibers respectively coupled to plural nodes of the fiber optic network. The optical signal generator includes an input optical channel providing a light beam and an acousto-optic modulator receiving the light beam and providing a plurality of separate output light beams. Each of the output light beams is independently optically coupled to a respective optical fiber. An acousto-optic modulator controller circuit drives the acousto-optic modulator to form the plural beams. The acousto-optic modulator controller circuit is also coupled to receive a data input and independently modulates the plural output beams based on the input data.

Preferably, plural input optical channels are provided. In a first embodiment each input optical channel creates M plural output beams coupled to M different fibers. Therefore, if the input optical channels are N in number, the plural output beams are M×N in number. As an example, if four input optical channels are provided and each creates 32 output beams, a total of 128 separate output beams and data channels may be provided. In another embodiment a plurality of input optical channels provide a plurality of light beams at a plurality of discrete wavelengths and plural output beams are created for each wavelength. Independently modulating the plural output beams based on the input data provides plural output wavelength division multiplexed data channels for each output beam.

In a further aspect, the present invention provides an optical data link adapted for use in a fiber optic network. The optical data link includes a physical layer comprising a plurality of optical fibers respectively coupled to plural nodes of the fiber optic network and providing bidirectional modulated optical signals. The physical layer further includes an optical signal generator having a source of at least one light beam and an acousto-optic circuit receiving the light beam and providing a plurality of separate output independently modulated light beams from the light beam. These output beams are optically coupled to respective optical fibers of the network. The optical data link also includes an upper logical data layer coupled to the physical layer and providing data to and from the physical layer. The upper data layer includes data switching information. The switching information may comprise routing information from a network layer in an application of the optical data link in a router.

In another aspect the present invention provides a method for transmitting data in a fiber optic network. The method comprises receiving data to be transmitted over the network and acousto-optically generating a plurality of separate output light beams from an input beam of light. The beams are independently modulated using the received data to form modulated optical signals. The modulated light beams are optically coupled to respective optical fibers. The data, in the form of the modulated optical signals, is provided to plural nodes of the fiber optic network via the plurality of optical fibers. In a preferred application, the received data to be transmitted comprises data packets having data routing information and the data packets are directed to the nodes based on the routing information.

Further aspects of the present invention will be appreciated by a review of the following detailed description of the invention.

### BRIEF DESCRIPTION OF THE DRAWINGS

FIG. 1 is a block schematic drawing of an improved fiber optic data network comprising optical data links employing multi-fiber optical signal generation in accordance with the present invention.

FIG. 2 is a schematic drawing illustrating the interface logic architecture of an optical data link of FIG. 1.

FIG. 3 is a block schematic drawing of a portion of the fiber optic data network of FIG. 1 illustrating multi-fiber optical signal generation in accordance with the present invention.

FIG. 4 is a block schematic drawing of one channel of an optical signal generator employed in the optical data link of FIG. 1, in accordance with the present invention.

FIG. 5A is a block schematic drawing of an AOM controller employed in the optical signal generator channel of FIG. 4, in accordance with the present invention.

FIG. 5B is a schematic drawing of an analog multiplier array employed in the AOM controller of FIG. 5A.

FIG. 6 is a block schematic drawing of a four channel AOM controller employed in the optical signal generator channel in accordance with a four channel embodiment of the present invention.

FIG. 7 is a block schematic drawing of an optical signal generator in accordance with an alternate embodiment of the present invention employing wavelength division multiplexing.

### DETAILED DESCRIPTION OF THE INVENTION

In FIG. 1, a schematic drawing of an improved fiber optic data network employing multi-fiber optical signal generation in accordance with the present invention is illustrated. As used herein the term fiber optic data network refers to any data network which employs optical data transmission or switching in at least a portion thereof and may include all optical networks or combined optical and wire and/or wireless networks. The illustrated network may be a WAN (Wide Area Network), LAN (Local Area Network) or portion of such networks. The illustrated network may also be a combination of linked networks of different types, such as the Internet.

Referring to FIG. 1, the fiber optic data network includes one or more optical data links 10. Each optical data link 10 is coupled to other points or nodes on the network via a plurality of optical fibers 12. In particular, the optical fibers 12 may couple the optical data link 10, to a network backbone, one or more gateway nodes, and one or more host nodes as generally illustrated. Gateway nodes 14 in turn may act as gateways to other networks through connections 18. The gateways 14 may provide optical fiber coupling to other fiber optic network locations along optical fibers 18 in which case one or more of the gateways 14 may also comprise optical data links in accordance with the present invention. Alternatively, gateways 14 may couple to all wire networks or all wireless networks or a combination of wired and wireless networks and in which case connections 18 will be appropriate wire or wireless communication links. As further illustrated in FIG. 1, in addition to optical fibers 12, the optical data link 10 also may be coupled to electrical communications connections 16. These electrical communications connections 16 may be wired or wireless connections and associated modems or other known connections employed. Electrical communications connections 16 may provide data inputs and data outputs which may correspond to direct data entry points into the optical network via the optical data link 10. Also, one or more of the electrical communications connections 16 may comprise connections to electrical nodes 15 of electrical networks.

The optical data link 10 employs a high speed optical signal generator which provides high data rate coupling of data to the plurality of optical fibers 12, which data flow may be from the electrical links 16 to the optical fibers 12 or may be from fibers 12 to other fibers 12. Therefore, it will be appreciated by those skilled in the art that the optical data link 10 may provide different functionality depending on the particular application. For example, in an application where the data network shown in FIG. 1 comprises a portion of the Internet, the optical data link 10 may comprise a router which receives data packets along fibers 12 and directs the data packets along different optical fibers 12. In other network applications, such as a LAN or WAN application, the optical data link 10 may provide a less sophisticated optical switching function to direct data flow to various nodes of the network along fibers 12. Also, where optical data link 10 comprises an initial data entry point into an optical network it may function as an optical transmitter receiving input data along one or more electrical links 16 and optically transmitting the data along optical fibers 12. Preferably, the optical data link 10 provides bidirectional data flow in which case it may be employed as an optical transceiver in some data network applications.

As one particular example of a fiber optic data network application, the optical data link 10 may be employed in the end portion of a high bandwidth connection to a large number of end users. Such applications are sometimes referred to as the “last mile” portion of high bandwidth communication networks. In such an application, the optical data link 10 will receive data from one or more fibers 12 close to the network backbone and provide them to end-user gateways 14 at locations close to the end-user homes or businesses, which gateways provide the data to the end users at home or business locations along lines 18. In such applications the data may comprise video, voice, cable TV or other continuous transmissions and packet data corresponding to data transmitted from the Internet. Other applications are possible, however, as will be appreciated by those skilled in the art.

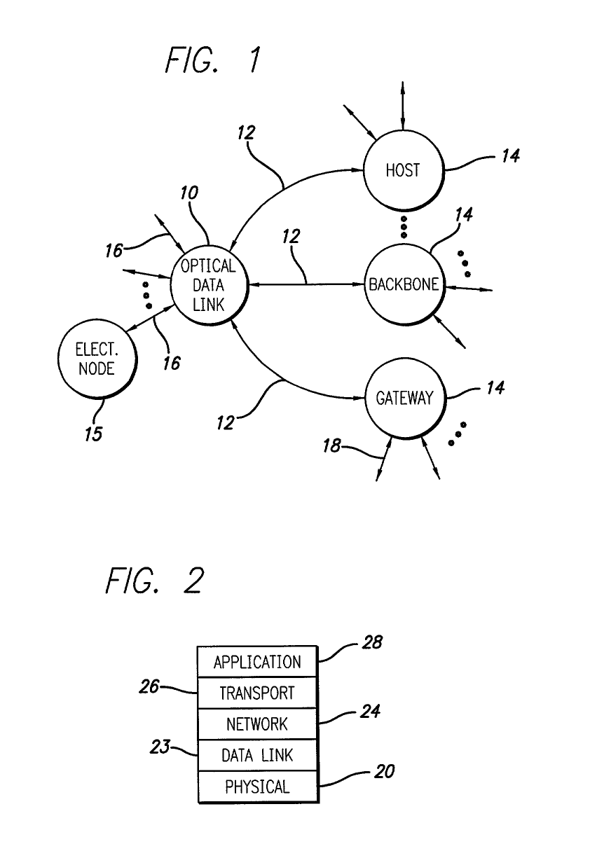

Referring to FIG. 2, a schematic drawing of the data architecture employed in the optical data link 10 of FIG. 1 is illustrated.

The optical data link 10 has the capability to handle a wide array of inputs and be configurable to handle various sizes of packets in packet switched systems. FIG. 2 shows the logical architecture diagram for a bidirectional data link interface. The architecture consists of multiple layers or levels as shown in the figure, which multi-layer architecture corresponds to the OSI (Open Systems Interconnection) model. Each layer is a logical entity, containing protocols that perform certain functions. The message software is partitioned into these layers for modular functionality. The physical layer 20 comprises the communication medium (i.e. the fiber 12 or radio or electronic link 16) and the associated communication device(s). Each layer uses the services provided by the one below and provides services to the one above. Thus, outgoing data/messages will flow from the top of the architecture down while incoming messages will flow from the bottom up. Where the optical data link 10 functions as a router or a switch the data will flow up to the appropriate level and then back down and out with the appropriate address or routing information added. In particular, when functioning as a router the data will flow up to the third layer, the Network layer 24 of FIG. 2, where the routing information for the packet is determined. When acting as a more basic switch in a network the data flow will be to the second layer, the Data Link layer 23 in FIG. 2, where connection address information is determined.

As a specific example the logic flow where the Application layer 28 has a message (file) to send will be considered. (In the OSI model the architecture has seven layers and the three upper layers, collectively illustrated by Application layer 28 in FIG. 2, are the application, presentation and session layers, as will be appreciated by those skilled in the art.) The Transport level breaks it into multiple units, adds sequence numbers (IDs) and other protocol information, for retransmission-reassembling purposes, and delivers the messages to the Network level 24, which adds its own information (network addresses), and with all this information, determines the next path. Essentially, the Network level 24 routes the message (or packet) via source/destination addresses in a manner well known in the art. The Data Link level 23 then adds its own header (for error detection/correction) and sends the packet to the next level. The Data Link level also coordinates point to point (link) transmission, or in the case of medium access control (MAC) determines transmission priority. The Physical level is the actual method of transmission and includes specifying the bit-encoding format. In the typical Transport level there are two protocols, TCP (Transmission Control Protocol) and UDP (User Datagram Protocol). TCP (reliable) is used for messages, which require verification and require an acknowledgement from the receiver. Without an acknowledgement, the message is retransmitted until an acknowledgement is received. UDP (typically used for lower cost but less reliable transmissions), does not require verification. If the data is lost, there is no retransmission. E-mail in most networks and in the Internet uses UDP. UDP is also used for some longer transmissions such as audio and video where the delays in re-transmitting the data only confuses the audio or video being received. Accordingly, different protocols may be employed depending on the particular application.

In a switching or routing application of optical data link 10, optical and/or electronic data is received at the data links 12, 16, respectively, through an appropriate interface in the physical link 20. Serial to parallel shift registers and high-speed logic circuitry format the data at a speed compatible with the switch operation. The network protocol preferably follows TCP for high reliability and UDP for Email and other low cost messaging. The transport layer 26 breaks the file into multiple units, adds sequencing numbers (Ids) among other things, for retransmission and assembling purposes and passes this data to the network (IP) layer 24. The network layer adds its own headers, such as addresses, and determines the next hop. The network layer routes the packet via source/destination addresses. The packet then flows down to the data link layer 23. The data link layer adds its own header, for error detection/correction, and inputs the signal to the physical layer where the signal is input to the optical signal generator, as described below. In a layer 2 switching operation where routing is not provided, e.g., in LAN switching operation, the data flow would only flow up to the data link layer 23. Furthermore, in an even simpler switching application the switching could be performed entirely at the physical level.

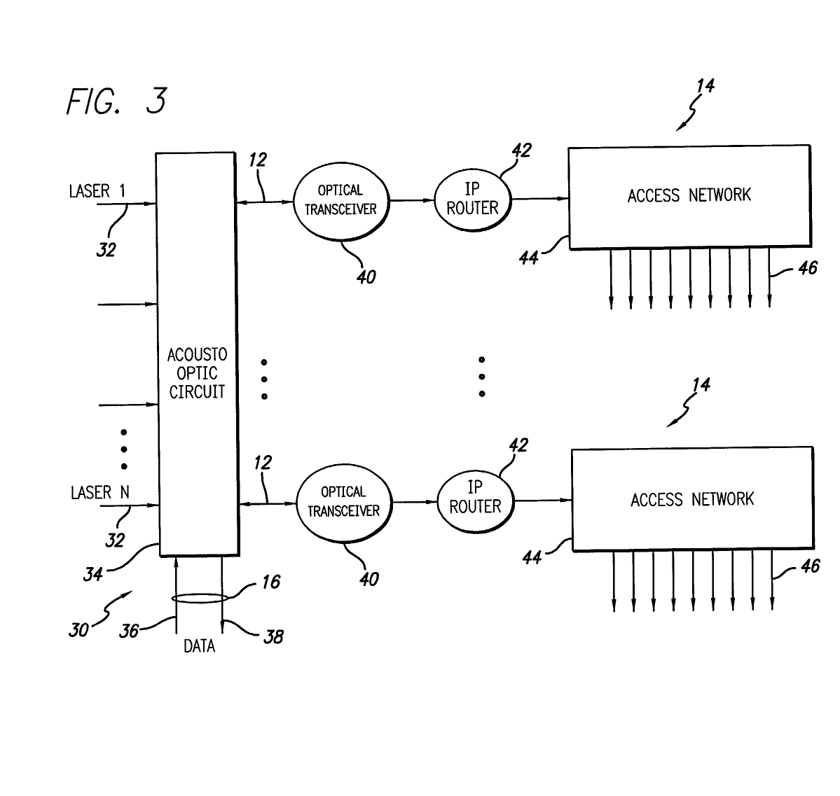

In FIG. 3 a block schematic drawing of a portion of the fiber optic data network of FIG. 1, illustrating an optical signal generator in accordance with the present invention, is shown.

Referring to FIG. 3, a portion of the physical layer 20 of the optical data link 10 incorporating an optical signal generator 30 is illustrated coupled to a plurality of optical fibers 12. The other ends of optical fibers 12 are illustrated coupled to a plurality of nodes 14 which are illustrated as gateway access points to electronic networks. It will be appreciated from the preceding discussion that other types of network nodes 14 may equally be coupled to optical fibers 12. As shown, the optical signal generator 30 includes a plurality of input optical channels 32, which as illustrated may be N in number. For example, four input optical channels may be provided in one embodiment which will be described in more detail below. In general, however, one or more input optical channels may be provided, with the maximum number of optical channels only being limited by the requirements of the particular application and the associated cost and space constraints. As shown, input optical channels 32 may be provided by lasers 1-N but other optical sources, such as light emitting diodes, or optical fibers, may potentially be employed for some applications. The input optical channels 32 are provided to acousto-optic circuit 34 which converts the input optical channels to a greater number of output optical channels or beams which are coupled to the fibers 12.

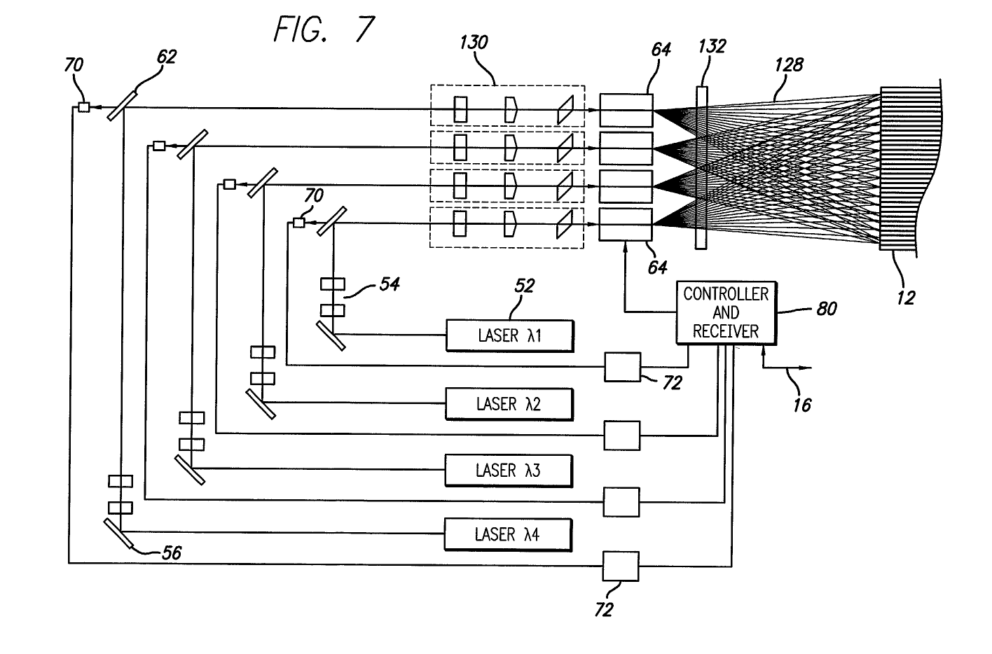

The number of output optical channels and fibers 12 will also vary with the particular application. For example, in one particular embodiment each input optical channel will create 32 output optical channels coupled to 32 fibers. In such an embodiment 2-32 output channels may equally be provided. A greater or lesser number of output optical channels and fibers may be provided for each input channel, however. The number of total output optical channels and fibers correspond to the number of input optical channels (N) times the channel multiplication factor (M) for each channel, i.e., N×M output channels. For example, if four input channels are provided and each input channel provides 32 output channels, then a total of 128 output channels and fibers would be provided. In an alternate embodiment which will be described below in relation to FIG. 7, the different input optical channels may correspond to different wavelengths of input light provided on the same fibers.

Still referring to FIG. 3, the acousto-optic circuit 34 also receives a data input along line 36 corresponding to the data to be transmitted along the individual fibers 12. The acousto-optic circuit 30 allows each output channel to be separately modulated by the data input along line 36, as will be described in more detail below in relation to preferred implementations of the circuit 30. Also, as illustrated in FIG. 3 in a preferred bidirectional implementation output data is provided along line 38 corresponding to data received along fibers 12 from other nodes in the network.

As further illustrated in FIG. 3, the opposite ends of fibers 12, located at the nodes 14, are coupled to conventional optical transceivers which will convert the incoming modulated optical signals to electrical signals and provide output electrical data signals. Where nodes 14 correspond to end user gateway nodes, the electrical data signals in turn will be provided to and to an access network 44 which provides the data to a plurality of end-users along lines 46 as illustrated. This gateway implementation may correspond to a last mile type of application such as described previously. One or more optical to electrical converters 40 and Internet Protocol (IP) router 42 may also be provided in optical data link 10 as part of the physical layer 20, e.g., where one or more of the nodes 14 in FIG. 3 is implemented as an optical data link in accordance with the present invention. Thus, conventional optical transceivers and routers may be combined with the optical signal generator 30 in various implementations of the optical data link 10, for example, in switching applications.

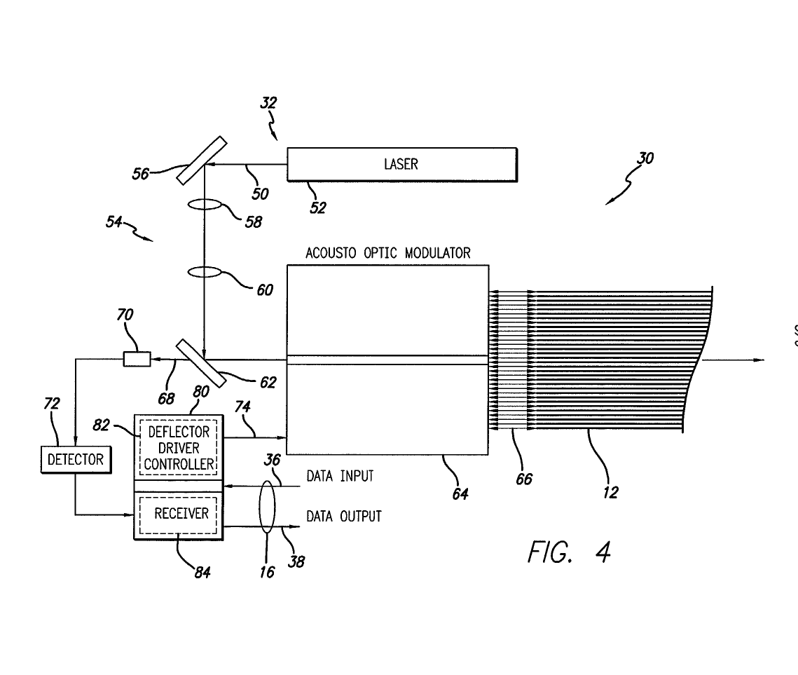

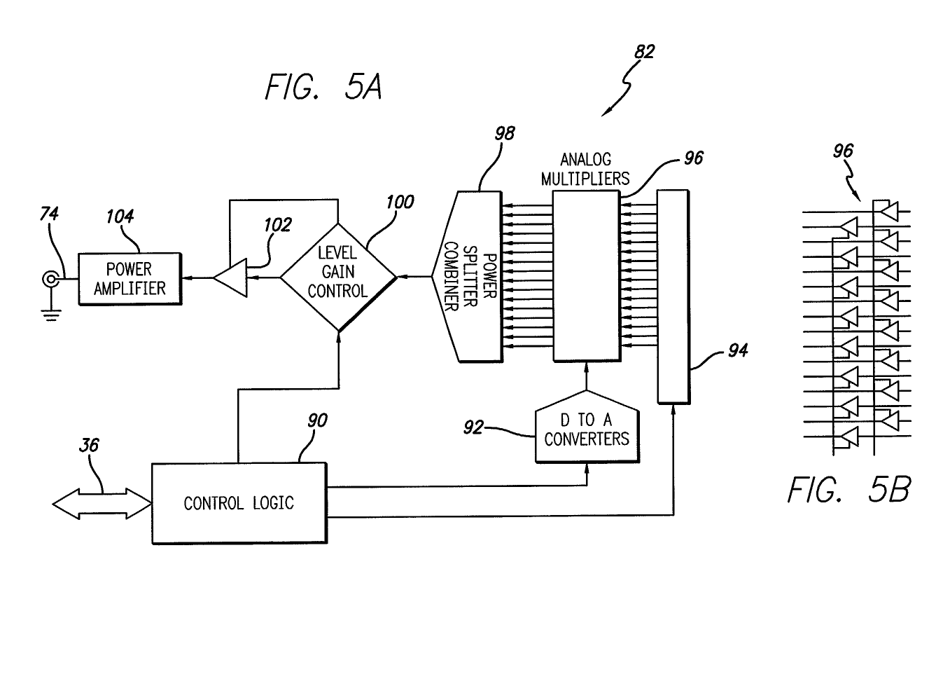

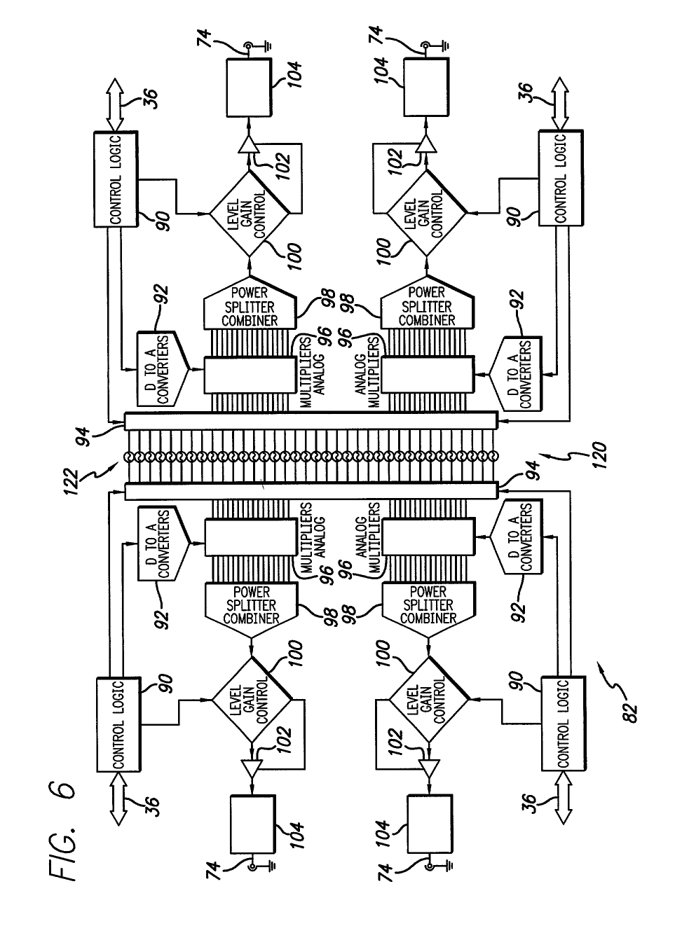

Referring to FIG. 4, a preferred embodiment of the optical signal generator 30 is illustrated corresponding to a single input optical channel 32. As shown, the input optical channel 32 may comprise a laser beam 50 provided from laser 52. Laser 52 may comprise a laser diode or a higher power laser, such as a CO2 or mixed gas laser, depending on the desired number of channels to be generated by the laser 52. The laser beam 50 is provided to an AOM (Acousto-Optic Modulator) 64 via optics 54. The AOM 64 may be a commercially available high-speed AOM which employs a transparent Bragg cell to reflect incoming laser beam by a variable angle depending on the drive signal applied thereto. In the specific implementation illustrated, optics 54 comprises mirror 56, lenses 58 and 60 and beam splitter 62. Such specific optics are purely illustrative in nature, however, since the specific application and the associated space constraints will dictate the particular optics employed. The AOM 64 receives a drive signal along line 74 from AOM deflector driver controller 82, which forms part of the controller circuit 80. The drive signal incrementally changes the index of refraction of the AOM 64 causing a finite lateral displacement of the laser beam. This signal is varied in calibrated increments to generate plural output beams 66, M in number. For example, M may be 2-32 in a presently preferred embodiment, but M may be greater than 32 if input beam power and fiber spacing permit. Each output beam may be modulated at high speed with an independent data channel in response to a data input for the plural data channels provided along line 36. For example, a 6 ns modulation rate (166 MHz) may be provided in one preferred implementation. A detailed implementation of the AOM deflector driver controller 82 will be described below in relation to FIG. 5. Alternatively, the output beams may be independently modulated with the data channels by a separate modulator or array of modulators after being output from AOM 64. The independently modulated beams 66 are individually coupled to respective fibers 12 as illustrated in FIG. 4. A suitable fiber spacing for beam coupling is provided. For example, a 0.160 inch fiber spacing may be suitable for a 32 output beam embodiment.

As described previously, the optical data link of the present invention provides a bidirectional optical transmission capability and the optical signal generator 30 may provide some or all of such a bidirectional capability by providing an optical receive function for light from fibers 12. This is illustrated in the embodiment of FIG. 4 by the incoming modulated light beam provided from fibers 12, through AOM 64 in a reverse direction to beam splitter 62. Beam splitter 62 may be a conventional beam splitter known in the art and may incorporate an optical filter to allow one wavelength of light for transmission and a second wavelength for incoming light. That is splitter 62 will pass incoming beam 68 at one wavelength and reflect outgoing beam 50 at a second wavelength. Alternatively, the beam splitter may employ the teachings of U.S. Pat. No. 6,134,050, the disclosure of which is incorporated herein by reference. In an embodiment employing the '050 patent, a beam altering element may be placed in the optical path between laser 52 and AOM 64. The resulting altered beam 50 may be annular in cross section and conventional splitter 62 replaced with an annular mirror reflecting the altered beam to the AOM. The incoming beam 68 may then pass through a central hole or transparent region in the annular reflector. In either embodiment, the incoming light beam 68 is provided to photodetector 70 which may comprise a conventional photodiode. The output photocurrent from photodetector 70 is provided to detector 72 which converts the photocurrent to a modulated voltage signal provided to receiver 84 in control circuit 80. The data encoded in the modulated light signals is decoded by receiver 84 and provided as an output along line 38. The photodetector 70, detector 72 and receiver 84 alternatively may be combined in a commercially available optical receiver which provides the data output 38 from light beam 68.

Referring to FIG. 5A and 5B, a preferred embodiment of the deflector driver controller circuit 82 is illustrated in a block schematic drawing. As illustrated, input data is provided along line 36 to control logic 90. The input data along line 36 may be in serial or parallel form and, for example, data input 36 may be a high-speed bus or other high-speed data interface. Control logic 90 may preferably be implemented as a programmable logic array, for example, an Altera programmable logic device may be used to implement the control logic. Control logic 90 converts the data from parallel to serial form if necessary and based on the number of output optical channels determines the control signals to be applied to the AOM 64 based on the input data. The control signals are output in digital form from control logic 90 to a digital to analog converter 92 which provides the analog driver control signal to analog multiplier array 96. The analog multiplier array 96 also receives a plurality of high frequency oscillator signals from oscillator array 94, which oscillator array 94 also receives an enable signal from the control logic 90. A preferred implementation of the analog multiplier array 96 is illustrated in FIG. 5B. As shown in FIG. 5B, the analog multiplier array 96 may comprise a parallel array of individual analog multipliers each receiving an oscillator input from the oscillator array 94. The individual analog multiplier outputs correspond to discrete frequency drive signals corresponding to discrete shifts of the deflection angle of the AOM 64. The output of the analog multiplier array 96 thus comprises a series of discrete drive signals which are selected or stepped in response to the control signal provided from control logic 90. These discrete drive signals are provided along parallel lines to splitter/combiner 98 which provides a single selected drive signal to level gain control circuit 100. Level gain control circuit 100 receives a level control signal from control logic 90 which may adjust the gain of the drive signal based on various factors which may be monitored by the system or input by the end user. The level adjusted signals are provided to an analog multiplier 102 which outputs a preamplified signal to power amplifier 104 which in turn provides the amplified drive signal along line 74 to the AOM 64.

Referring to FIG. 6, a preferred embodiment of a four channel deflector driver controller circuit is illustrated. The embodiment of FIG. 6 generally corresponds to the embodiment of FIG. 5 duplicated four times to provide parallel drive signals for separate AOMs 64. Therefore, the majority of the circuit components illustrated in FIG. 6 have the same reference numerals as described above in relation to FIG. 5 and their operation will not be repeated. The illustrated four channel embodiment provides some space savings by sharing circuit components which may be combined across the multiple channels. In particular, a shared oscillator array 120 is employed in the embodiment of FIG. 6 as illustrated. This is possible since each AOM 64 will preferably be of identical construction and therefore identical oscillators may be used to provide the discrete deflection drive signals in each channel. In particular, a plurality of individual oscillators 122 may be configured in a single array as illustrated. This provides a more compact layout and allows sharing of the oscillators between the channels. Therefore, it will be appreciated that the four channel deflector driver controller illustrated in FIG. 6 may be compactly laid out on a single printed circuit board providing cost and space advantages in one implementation of the present invention.

Referring to FIG. 7, an alternate embodiment of the signal generator of the present invention is illustrated employing wavelength division multiplexing along the optical fibers 12. In FIG. 7, a four channel embodiment is shown which provides four separate wavelengths of light from four lasers 52. It will be appreciated that four input optical channels and four wavelengths are purely for illustration purposes and a greater or lesser number of channels and wavelengths may be provided. In general, N lasers 52 with N discrete optical wavelengths are implied in the embodiment of FIG. 7. The manner in which the individual optical channels are provided to a plurality of fibers 12 and individually modulated with input data using an array of AOMs 64 and controller circuit 80 will be appreciated from the preceding embodiments. In the embodiment of FIG. 7, however, each separate AOM 64 provides the output optical channels to the same array of fibers 12 but with each set of output optical channels at a different wavelength of light. The discrete wavelength output channels are illustrated by separate output channels 128 in FIG. 7.

The number of output beams in such a wavelength division multiplexing embodiment thus corresponds to the multiplication factor (M) for a single channel. The use of multiple wavelengths provides for the multiple data channels on each fiber through the use of wavelength division multiplexing. Thus, with N input channels with N discrete wavelengths, a total of N×M data channels are provided. As an example, if each input channel provides 32 output channels (M=32) and four wavelengths of light are provided on four respective input channels (N=4), then 32 output beams and fibers would be provided. Each fiber would receive four separate wavelengths of light and data transmitted in four separate wavelength division multiplexed channels. Therefore, 128 separate data channels would be provided.

In the embodiment of FIG. 7, additional optics may be provided in addition to the optics 54 and beam splitter 62 described in the previous embodiments. In particular additional optics 130 which may comprise one or more lenses in each input optical channel may be provided as illustrated. Also, additional optics 132 in the output channels may be provided to allow the array of AOMs 64 to all correctly optically couple to the array of fibers 12. More specifically, since each AOM 64 is shifted to a slightly different optical axis from the adjacent AOM, corrective optics 132 will be provided to allow each of the channels 128 to optically couple to the fibers 12 without undue power loss due to misalignment with the fibers. Preferably, optics 132 will flatten the optical field allowing each of the plural output beams to enter the respective fiber at substantially 0 degrees.

In the embodiment of FIG. 7, bi-directional transmission may be provided. Therefore, beam splitters 62, photodetectors 70, detectors 72 and receiver circuitry in controller 80 may be provided as generally described previously. Each filter 62 may be set to a different wavelength to allow bi-directional operation at plural wavelengths.

In view of the foregoing, it will be appreciated that an optical signal generator has been disclosed providing a number of the advantageous features. In particular, high-speed optical signal generation into a plurality of optical fibers is provided by the present invention in a compact and cost-effective manner. Also, an optical data link according to the present invention may be employed in a variety of networking applications including optical switches and routers.

The specific advantages and features of the present invention will vary with the particular application and are too numerous to identify for every possible application. One specific example of an implementation for one application will illustrate such potential advantages, particularly in endpoint “last mile” communications applications. The specific example will assume an embodiment of the optical signal generator which converts four beams of laser light into 128 separate output laser beams. The associated method permits the brightness of each of the 128 beams of light to be modulated and individually addressed with differing optical frequencies, with digital data at a clock rate of 200 MHz per second. This method permits the brightness of each of the 32 beams of light to be compensated so that no matter which combinations of beams are on in any moment, or which of 256 levels of brightness are selected, without deviation, the brightness in each of the 32 beams always matches exactly the assigned value ranging between 0 and 255.

The total information bandwidth of the optical data link in this example is 51.2 Gbits/sec. capable of delivering a secure downstream subscriber data stream. As will be described in detail, the system is capable of modulating each of the 128 beams every 5 ns or at 200 Mbits/sec. By use of known high speed A/D circuitry in combination with grayscale technology, 8 bits of data can be transmitted in each clock cycle. Additionally, employing a basic A/D converter is the equivalent of deMUXing a high-speed data rate, i.e., from high to low rates, and therefore eliminates deMUXing requirements.

Since the optical signal generator simultaneously creates 32 individual channels each having 8-bit grayscale, the data in each of the 32 channels, by definition, is unrelated, although it can as easily be used to multi-cast data. The electronics can therefore be clocked at 200 MHz by merely changing the reference clock. As a result, each input optical channel develops 32 channels of data or can be described as having 51.2 G/bits of data throughput per channel. In a configuration that has four channels in a single package, the resultant system delivers a data throughput of 204.8 G/bits of data into 128 single mode fibers by running the reference clock at 200 MHz.

The system design delivers downstream data to a gateway device that converts the optical digital data into electronic digital data, which in turn can be delivered in real-time to any number of business, entertainment or information appliances. This implementation is preferably designed as a dual direction transmission system that can inexpensively deliver and receive real-time content to a household gateway or to an optical PC based network card. Dual directionality is achieved through the use of WDM (wavelength-division-multiplexing) type gratings separating the offset frequencies used for transmission in two directions. Single mode fiber connections using bidirectional data transfer in the same fiber using common optical transceivers offset in optical frequency from the downstream optical frequency may thus be provided. By creating a grayscale data bit, this system has the capability of delivering a secure downstream subscriber data stream.

In summary, this example of an implementation of the present invention creates 128 laser outputs from only 4 laser inputs. This extremely low cost system based on the need for only 4 low cost 850 nm semiconductor lasers, results in a versatile and highly flexible end-point data communication system with the high speed advantages of fiber communications and the flexibility and versatility of 128 high speed fiber outputs to interface with even the most advanced end-point communication applications. A bi-directional capability with a second optical switching coupled through the same fiber trunks using optical gratings to separate the signals operating at 10 nm difference wavelengths is provided. The result is a versatile end point communication system with a total system data handling capacity of 51.2 Gbits/sec.

Although the present invention has been described in relation to specific embodiments it should be appreciated that such embodiments are purely for illustrative purposes and should not be viewed as limiting in any way.

What is claimed is:

1. An optical signal generator adapted for use in a fiber optic network, comprising:
a plurality of optical fibers respectively coupled to plural nodes of the fiber optic network;
an input optical channel providing a light beam;
an acousto-optic modulator receiving the light beam and providing a plurality of separate output light beams independently optically coupled to respective optical fibers; and
a deflector controller circuit, coupled to drive the acousto-optic modulator to create the plural output beams.

2. An optical signal generator as set out in claim 1, wherein said input optical channel comprises a laser providing said light beam.

3. An optical signal generator as set out in claim 2, wherein said laser comprises a laser diode.

4. An optical signal generator as set out in claim 2, wherein said laser comprises a gas laser.

5. An optical signal generator as set out in claim 1, wherein said plural output beams are M in number.

6. An optical signal generator as set out in claim 5, wherein M is in the range 2-32.

7. An optical signal generator as set out in claim 1, wherein said deflector controller circuit is coupled to receive a data input and independently modulates the plural output beams based on the input data.

8. A multi-channel optical signal generator adapted for use in a fiber optic network, comprising:
a plurality of optical fibers respectively coupled to plural nodes of the fiber optic network;
a plurality of input optical channels providing a plurality of input light beams;
an acousto-optic modulator array receiving the plurality of input light beams and providing a plurality of separate output light beams independently optically coupled to respective optical fibers; and
a deflector controller circuit, coupled to drive the acousto-optic modulator array, for driving the modulator array to create the plural output beams.

9. An optical signal generator as set out in claim 8, wherein said deflector controller circuit is coupled to receive a data input and independently modulates the plural output beams based on the input data.

10. An optical signal generator as set out in claim 8, wherein the input optical channels are N in number and wherein said plural output beams are M×N in number.

11. An optical signal generator as set out in claim 10, wherein there are 2-4 input optical channels and 2-32 output beams.

12. An optical signal generator as set out in claim 11, wherein there are 4 input optical channels and 128 output optical channels.

13. An optical signal generator as set out in claim 10, wherein said acousto-optic modulator array comprises N acousto-optic modulators.

14. A wavelength division multiplexed optical signal generator adapted for use in a fiber optic network, comprising:
a plurality of optical fibers respectively coupled to plural nodes of the fiber optic network;
a plurality of input optical channels providing a plurality of light beams at a plurality of discrete wavelengths;
an acousto-optic modulator receiving the plurality of light beams and providing a plurality of separate output light beams independently optically coupled to respective optical fibers; and
a controller circuit, coupled to receive a data input and coupled to drive the acousto-optic modulator to create the plural output beams, for independently modulating the plural output beams based on the input data to provide plural output wavelength division multiplexed data channels for each output beam.

15. An optical signal generator as set out in claim 14, wherein the input optical channels are N in number, the output beams are M in number and wherein the total output data channels are M×N in number.

16. An optical data link adapted for use in a fiber optic network, comprising:
a physical layer comprising a plurality of optical fibers respectively coupled to plural nodes of the fiber optic network and providing bidirectional modulated optical signals, an optical signal generator comprising a source of at least one light beam, and an acousto-optic circuit receiving the light beam and from said light beam providing a plurality of separate output independently modulated light beams optically coupled to respective optical fibers; and
an upper logical data layer coupled to the physical layer and providing data to and from the physical layer, the upper data layer including data switching information.

17. An optical data link as set out in claim 16, wherein said upper data layer comprises a data link layer including network address information.

18. An optical data link as set out in claim 16, wherein said upper data layer comprises a network layer including network routing information.

19. A method for transmitting data in a fiber optic network, comprising:
receiving data to be transmitted over the network;
acousto-optically generating a plurality of separate output light beams from an input beam of light;
independently modulating the light beams using the received data to form modulated optical signals;
optically coupling the modulated light beams to respective plural optical fibers; and
providing the data in the form of the modulated optical signals to plural nodes of the fiber optic network via the plurality of optical fibers.

20. A method for transmitting data in a fiber optic network as set out in claim 19, wherein the received data to be transmitted comprises data packets having data routing information and wherein the method comprises directing the data packets to the nodes based on the routing information.
